(19) United States
(12) Patent Application Publication
(10) Pub. No.: US 2026/0211304 A1
(43) Pub. Date: Jul. 23, 2026

(54) SINGLE LCD PROJECTOR STRUCTURE SWITCHABLE BETWEEN ULTRA-SHORT DISTANCE PROJECTION AND MEDIUM-LONG DISTANCE PROJECTION AND SINGLE LCD PROJECTOR

(71) Applicant: JoySniffler Technology(Dongguan) Co.,Ltd., Dongguan (CN)

(72) Inventors: Lingxiao Ou, Beijing (CN); Yanqin Luo, Macheng (CN)

(21) Appl. No.: 19/026,655

(22) Filed: Jan. 17, 2025

(51) Int. Cl. G03B 21/14; G03B 21/00; G03B 21/20; G03B 21/28

(52) U.S. Cl. CPC G03B 21/142; G03B 21/006; G03B 21/2033; G03B 21/208; G03B 21/28

(57) ABSTRACT

Disclosed is a single LCD projector structure switchable between ultra-short distance projection and medium-long distance projection including a projection module. The projection module includes an LED light source, a condenser cup, a collimating Fresnel lens, an LCD light valve and a focusing Fresnel lens arranged in sequence. The single LCD projector structure further includes a first total reflection mirror and an objective lens module including an objective lens ring and a telescopic mechanism for stretching and retracting of the objective lens ring. A single LCD projector is also provided. The objective lens is shared by ultra-short distance projection and the medium-long distance projection without changing its optical characteristics, thus the objective lens group can move rapidly in a large range and fine focusing is performed in the far end ring or the near end ring, which improves the flexibility and practicability of projection and is suitable for various application scenes.

### TECHNICAL FIELD

The present disclosure relates to a projection device, and in particular, to a single LCD projector structure switchable between ultra-short distance projection and medium-long distance projection and a single LCD projector.

### BACKGROUND

The single LCD projector utilizes a full-color liquid crystal screen (LCD) as a light valve, and is composed of an LED lighting system, an LCD, a Fresnel lens, a lens, a reflector, etc. Compared with the projection systems adopting three LCDs, a DLP or a DMD on the market, the projector adopting a single LCD has much lower production cost due to its simple structure, low raw material cost and less difficulty in production and processing, and is the low-end product with lower price. In recent years, the market share of the single LCD projector is improved year by year among all projector types.

The mainstream single LCD projectors on the market usually take wall surfaces or ceilings as target projection planes, and their structural design and optical component design (such as adopting a lens with a medium-long focal length and a limited lens focusing range) need to give consideration to a medium-long projection distance of 1 m or more, which limits the minimum imaging distance of the single LCD projectors and thus those projectors are unable to image clearly and out of focus on a relatively close projection surface (<=0.3 m). In addition, there is a type of ultra-short distance projectors on the market that can project an image of 50-100 inches at an ultra-short distance (0.25 m-0.5 m). This type of projectors achieve an ultra-low projection ratio mainly relying on the DLP technology or the DMD technology and specially designed ultra-short-focus optical lens modules. However such projectors cannot achieve medium-long distance projection. Their technical architecture is significantly different from and more complex than that of the single LCD projection technology, consequently their material cost is much higher than that of a single LCD projector, and the market positioning and selling prices are much higher than those of a single LCD projector.

### SUMMARY

The present disclosure provides a single LCD projector structure switchable between ultra-short distance projection and medium-long distance projection, for solving the compatibility problem of ultra-short distance projection (<=0.3 m) and medium-long distance projection (>=1 m), and expanding the application scenes of the single LCD projector, so that not only the wall surfaces and the ceilings can be used as projection surfaces for medium-long projection, but also the desktops and the ground can be used as projection surfaces for ultra-short distance projection. Furthermore, by designing detachable components, the volume of the whole machine after being packaged is reduced.

According to one aspect of the present disclosure, a single LCD projector structure switchable between ultra-short distance projection and medium-long distance projection is provided, which includes a projection module, and the projection module includes an LED light source, a condenser cup, a collimating Fresnel lens, an LCD light valve and a focusing Fresnel lens arranged in sequence, and the single LCD projector structure further includes:
a first total reflection mirror;
an objective lens module, including:
   an objective lens ring;
   a telescopic mechanism configured for stretching and retracting of the objective lens ring in a Z-axis direction thereof;
wherein, light beams are emitted from the LED light source, pass through the condenser cup, and are collimated by the collimating Fresnel lens, pass through the LCD light valve and the focusing Fresnel lens along a first optical axis, and are reflected by the first total reflection mirror, which is 45 degrees tilted relative to the first optical axis, to form a right-angle reflection and exit through the objective lens module for projection imaging along a second optical axis X2.

In an embodiment, the projection module is tilted relative to a horizontal plane to form an angle c therebetween, the light beams are projected along the first optical axis, reflected by the first total reflection mirror tilted 45 degrees relative to the first optical axis to form a right-angle reflection, and pass through the objective lens module along the second optical axis.

In an embodiment, the single LCD projector structure further includes a second total reflection mirror located after the objective lens module along the second optical axis for reflecting the light beams and folding an optical path of the light beams, an included angle between the second optical axis and the second total reflection mirror is a1, an included angle b is formed between the second optical axis and a vertical line passing through the second total reflection mirror, and an included angle a2 is formed between the vertical line and the second total reflection mirror.

In an embodiment, a reflective surface of the second total reflection mirror is a plane, and the included angle a1 is a light incident angle and equal to the included angle a2 which is a light ejection angle.

In an embodiment, relationships of the included angles a1, a2, b, and the angle c meet:

$$a 1 = a 2 ;$$

$$a 1 + b + a 2 = 180 ° ;$$

because the first total reflection mirror and the first optical axis form an included angle of 45°, the light beams are perpendicularly reflected by the first total reflection mirror to form the second optical axis, and an included angle between the first optical axis and the second optical axis is 90°, the vertical line is perpendicular to the horizontal plane, and a sum of inner angles of a quadrilateral formed by the first optical axis, the second optical axis, the vertical line and the horizontal plane is 360°,

$$( 180 ° - c ) + 90 ° + 90 ° + b = 360 ° ,$$

thus: b=c.

In an embodiment, the included angle b and the angle c are ranged from 64° to 70°, and the included angles a1 and a2 are ranged from 55° to 58°.

In an embodiment, the telescopic mechanism includes:
a fixing sleeve, wherein an outer side of the fixing sleeve is fixed with two positioning pins symmetrical to each other and defined with vertical grooves;
a rotating sleeve, wherein an outer side of the rotating sleeve is provided with inclined grooves corresponding to each other and I-shaped positioning sliding grooves symmetrical to each other, the rotating sleeve is sleeved on the fixing sleeve, and the positioning pins are received in the I-shaped positioning sliding grooves for limiting and sliding;
at least two connecting pins, wherein the at least two connecting pins pass through the inclined grooves and the vertical grooves of the fixing sleeves correspondingly to fixedly connect with the objective lens ring.

In an embodiment, the second total reflection mirror is detachably disposed.

A single LCD projector is also provided, the single LCD projector includes the single LCD projector structure switchable between ultra-short distance projection and medium-long distance projection described above.

According to the single LCD projector structure switchable between ultra-short distance projection and medium-long distance projection of the present disclosure, the objective lens is shared by both the ultra-short distance projection and the medium-long distance projection without changing the optical characteristics of the part, so that the objective lens group can move rapidly in a large range between the far end ring and the near end ring along the optical axis and fine focusing is performed in the far end ring or the near end ring, this design not only simplifies the structure of the projection equipment, but also improves the flexibility and practicability of projection and is suitable for various application scenes.

### BRIEF DESCRIPTION OF THE DRAWINGS

The accompanying drawings, which constitute a part of the present disclosure, are used to provide a further understanding of the present disclosure, and the exemplary embodiments of the present disclosure and the description thereof are used to explain the present disclosure, and do not constitute an improper limitation to the present disclosure. In the drawings:

FIG. 1 is a schematic structural diagram of an embodiment of the present disclosure;

FIG. 2 is a schematic explosive diagram of an objective lens module according to an embodiment of the present disclosure;

FIG. 3 is a schematic top view of the objective lens module according to an embodiment of the present disclosure;

FIG. 4 is a schematic side view of the objective lens module according to an embodiment of the present disclosure;

FIG. 5 is a schematic structural diagram showing a long-distance projection of a single LCD projector according to an embodiment of the present disclosure;

FIG. 6 is a schematic structural diagram showing a medium-distance projection of the single LCD projector according to an embodiment of the present disclosure; and

FIG. 7 is a schematic structural diagram of a short-distance projection of the single LCD projector according to an embodiment of the present disclosure.

### DETAILED DESCRIPTION OF THE EMBODIMENTS

It should be noted that, in the case of no conflict, the embodiments in the present disclosure and the features in the embodiments may be combined with each other. The present disclosure will be described in detail below with reference to the accompanying drawings and in combination with the embodiments.

It should be noted that, unless otherwise specified, all technical and scientific terms used in this disclosure have the same meaning as commonly understood by a person of ordinary skill in the art to which the present disclosure belongs.

In the present disclosure, unless otherwise stated, the words such as “up”, “down”, “top”, and “bottom” which are used to indicate directions are generally directed to directions shown in the drawings, or to components themselves in the vertical or gravity direction. Similarly, for ease of understanding and description, “inner” and “outer” refer to the inner and outer directions relative to the contours of the components themselves. The above words are not used to limit the present disclosure.

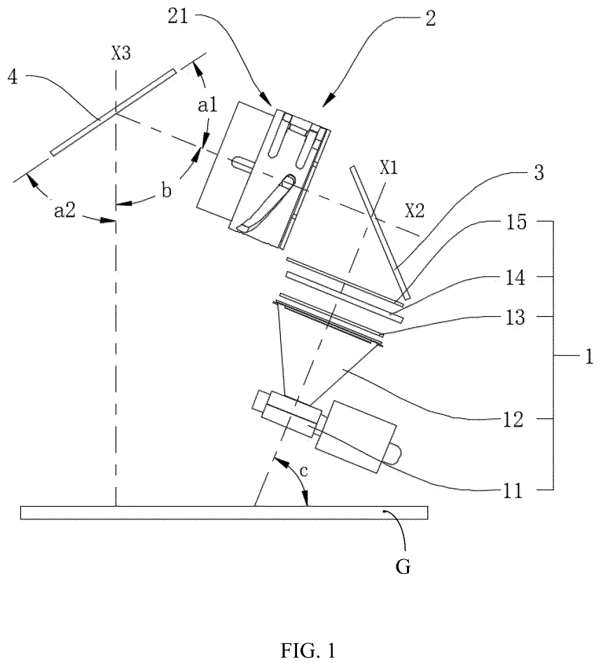

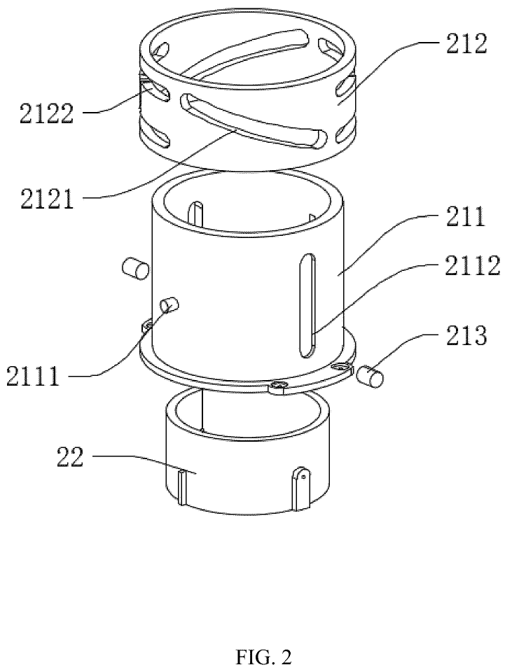

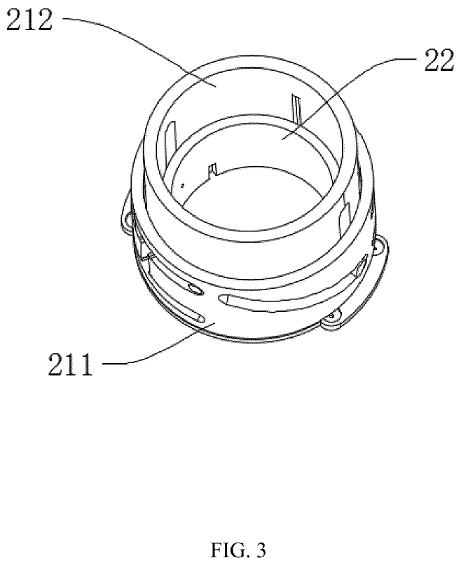

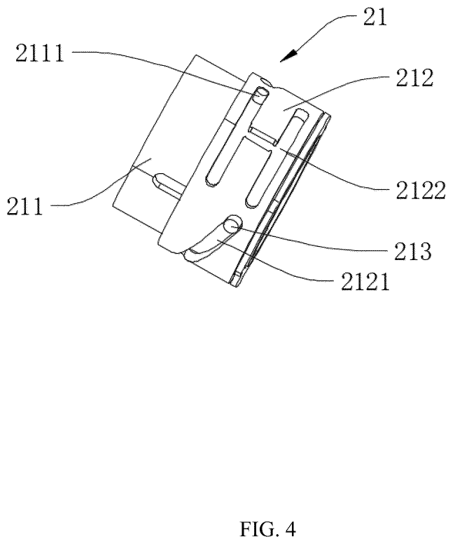

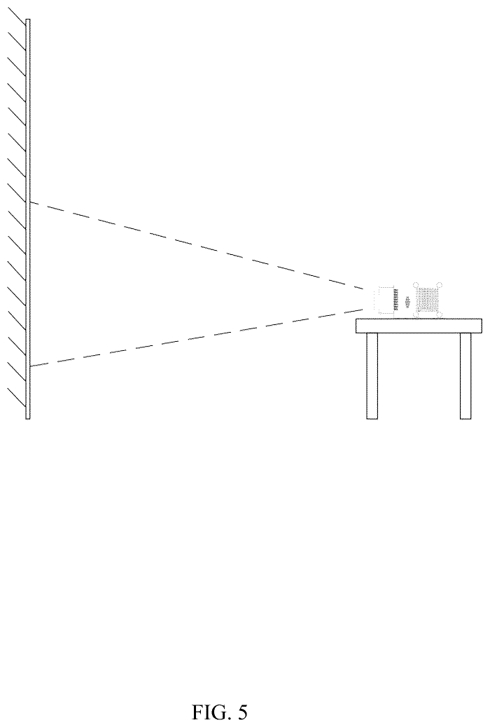

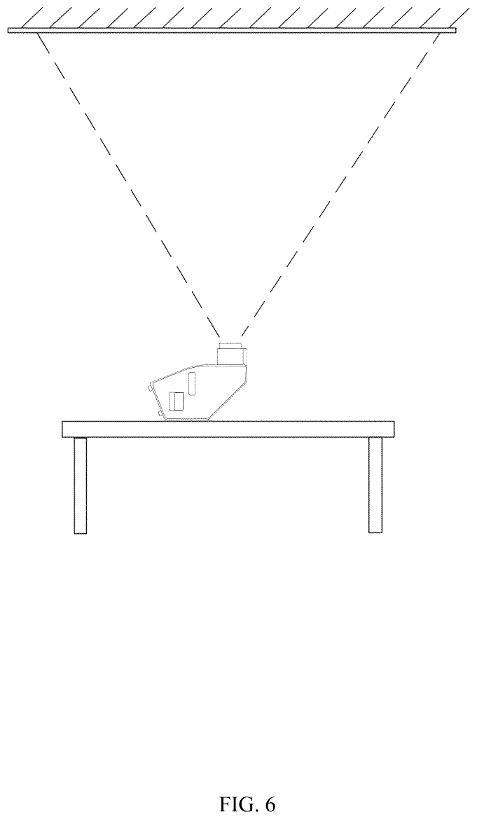

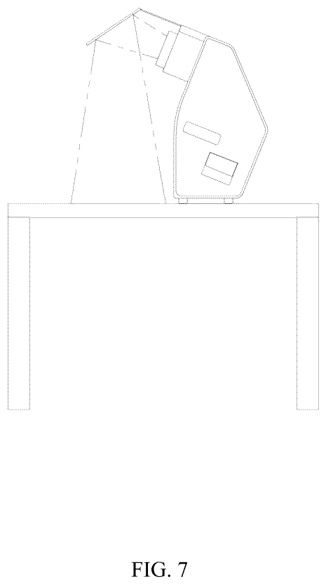

Referring to FIGS. 1-7, a single LCD projector structure switchable between ultra-short distance projection and medium-long distance projection according to the present disclosure includes a projection module 1, and the projection module 1 includes an LED light source 11, a condenser cup 12, a collimating Fresnel lens 13, an LCD light valve 14 and a focusing Fresnel lens 15 which are sequentially arranged. The single LCD projector structure switchable between ultra-short distance projection and medium-long distance projection further includes:
a first total reflection mirror 3;
an objective lens module 2 including a telescopic mechanism 21 and an objective lens ring 22, where the telescopic mechanism 21 is configured for stretching and retracting of the objective lens ring 22 in a Z-axis direction thereof. The telescopic mechanism can perform focusing driven by a motor or by a hand. The electric focusing tends to increase the manufacturing cost and space occupied, and the manual focusing can make an objective lens group move rapidly in a large range between a far end ring and a near end ring along an optical axis, which can reduce the cost and the space occupied, and focus on and clearly image on a closer projection surface (<=0.3 m) as for projection distance selection.

Light beams are emitted from the LED light source 11, pass through the condenser cup 12, and are collimated by the collimating Fresnel lens 13, pass through the LCD light valve 14 and the focusing Fresnel lens 15 along the optical axis X1 (the first optical axis), and are reflected by the first total reflection mirror 3, which is 45 degrees tilted relative to the light axis X1, to form a right-angle reflection and exit through the objective lens module 2 for projection imaging along an optical axis X2 (the second optical axis).

According to the single LCD projector structure switchable between ultra-short distance projection and medium-long distance projection of the present disclosure, the objective lens is shared by both the ultra-short distance projection and the medium-long distance projection without changing the optical characteristics of the part, so that the objective lens group can move rapidly in a large range between the far end ring and the near end ring along the optical axis and fine focusing is performed in the far end ring or the near end ring, this design not only simplifies the structure of the projection equipment, but also improves the flexibility and practicability of projection and is suitable for various application scenes.

Furthermore, a second total reflection mirror 4 is also included. The projection module 1 is tilted relative to a horizontal plane to form an angle c between them. The light beams are projected along the optical axis X1, reflected by the first total reflection mirror 3 tilted 45 degrees relative to the optical path X1 to form a right-angle reflection, and exits along the optical axis X2 to pass through the objective lens module 2 and be projected to the second total reflection mirror 4 for folding the optical path.

The second total reflection mirror 4 is arranged to form a second configuration and fold the optical path, so that the projection distance is changed and short-distance projection is realized. The second total reflection mirror 4 is located on an optical path of the objective lens module 2, and an ultra-low projection ratio is achieved without employing the DLP technology or the DMD technology and specially designed ultra-short-focus optical lens modules.

The projection module 1 is tilted relative to the horizontal plane with an angle c between them. An included angle between the optical axis X2 and the second total reflection mirror 4 is a1. An included angle b is formed between the optical axis X2 and a vertical line X3 passing through the second total reflection mirror 4, and an included angle a2 is formed between the vertical line X3 and the second total reflection mirror 4.

A reflective surface of the second total reflection mirror 4 is a plane, and a1 is a light incident angle and equal to a2 which is a light ejection angle. The planar reflection mirror can effectively change the direction of the optical path, and the planar reflection mirror has a relatively simple structure, low manufacturing and processing cost, and is suitable for large-scale production and application.

Relationships of the critical angles a1, a2, b, and c meet:

$$a 1 = a 2 ;$$

$$a 1 + b + a 2 = 180 ° .$$

Because the first total reflection mirror and the optical axis X1 form an included angle of 45°, the light beams along the optical axis X1 is perpendicularly reflected by the first total reflection mirror to form the optical axis X2, and an included angle between the optical axes X1 and X2 is 90°. The optical axis (vertical line) X3 is perpendicular to the horizontal plane, and the sum of inner angles of a quadrilateral formed by the optical axes X1, X2, X3 and the horizontal plane is 360°.

$$( 180 ° - c ) + 90 ° + 90 ° + b = 360 ° ,$$

thus: b=c.

Sizes of the angles b and c are ranged from 64° to 70°, and sizes of the angles a1 and a2 are ranged from 55° to 58°.

It is found through experiments that when the sizes of the angles b and c are ranged from 64° to 70°, a proper balance among the size of the whole projector, the imaging effect and the structural rationality can be obtained, and meanwhile, the sizes of the angles a1 and a2 are calculated to be ranged from 55° to 58°.

The telescopic mechanism 21 includes:
a fixing sleeve 211, where an outer side of the fixing sleeve 211 is formed with two positioning pins 2111 symmetrical to each other and defined with two vertical grooves 2112;
a rotating sleeve 212, where an outer side of the rotating sleeve 212 is provided with inclined grooves 2121 corresponding to each other and I-shaped positioning sliding grooves 2122 symmetrical to each other, the rotating sleeve 212 is sleeved on the fixing sleeve 211, and the positioning pins 2111 are received in the I-shaped positioning sliding grooves 2122 for limiting and sliding;
at least two connecting pins 213, where the two connecting pins 213 respectively pass through the inclined grooves 2121 and the vertical grooves 2112 of the fixing sleeves 211 to fixedly connect with the objective lens ring 22.

When the positioning pins 2111 moves in upper transverse sliding grooves or lower transverse sliding grooves of the I-shaped positioning sliding grooves 2122, the rotating sleeve 212 can freely rotate on the fixing sleeve 211 and around the Z axis. The rotation of the inclined grooves 2121 drives the connecting pins 213 to move up and down along the Z axis in a small range in the vertical grooves 2112, so that precise focusing is realized both at the near end ring and the far end ring. When the positioning pins 2111 are aligned with vertical grooves of the I-shaped positioning sliding grooves 2122, the positioning pins 2111 can be moved to the highest points: the upper transverse sliding grooves of the I-shaped positioning sliding grooves 2122, and to the lowest points: the lower transverse sliding grooves of the I-shaped positioning sliding grooves 2122. When the rotating sleeve 212 is moved up and down on the fixing sleeve 211 along the Z axis, the inclined grooves 2121 move up and down following the rotating sleeve 212 without rotating and drive the connecting pins 213 to synchronously move up and down in the vertical grooves along the Z axis, so that the objective lens ring 22 moves to the far end point to realize ultra-short distance projection and to the near end point to realize medium-long distance projection.

The second total reflection mirror 4 is detachably disposed.

The second total reflection mirror 4 is arranged to further fold the optical path, so that the angle a1 is formed between the second total reflection mirror 4 and the optical axis X2 and the second total reflection mirror 4 reflects to form the optical axis X3 perpendicular to the horizontal plane G, the angle between the second reflection mirror 4 and the optical axis X3 is a2, and the included angle between the optical axis X2 and the optical axis X3 is b. In this configuration the second total reflection mirror 4 can be rapidly removed from the main body, and the objective lens can project images directly.

In the single LCD projector of the present disclosure, the single LCD projector structure switchable between ultra-short distance projection and medium-long distance projection according to any one of 1-8 is included. According to the structure of the single LCD projector structure switchable between ultra-short distance projection and medium-long distance projection, a single optical objective lens is employed, and the joining of the second reflection mirror and the improvement of the telescopic lens group form two configurations of the projector body, thus the application range of the single LCD projector is expanded, not only the wall surfaces and the ceilings can be used as projection surfaces for medium-long projection, but also the desktops and the ground can be used as projection surfaces for ultra-short distance projection.

Apparently, the embodiments described above are only a part and not all of the embodiments of the present disclosure. All other embodiments obtained by a person of ordinary skill in the art based on the embodiments of the present disclosure without creative efforts shall fall within the claimed scope of the present disclosure.

It should be noted that the terms used herein is for the purpose of describing exemplary embodiments only and is not intended to limit the exemplary embodiments of the present disclosure. As used herein, the singular forms are intended to include the plural forms as well, unless the context clearly indicates otherwise, and it is also to be understood that when terms “include” and/or “comprise” are used in this specification, these terms indicate the presence of features, steps, work, devices, components, and/or combinations thereof.

It should be noted that terms “first”, “second” and the like in the specification, claims, and accompanying drawings of this disclosure are used to distinguish similar objects, and they are not inevitably indicate a specific order or sequence. It should be understood that the data used in this way can be interchanged under appropriate circumstances, so that the embodiments of the present disclosure described herein can be implemented in an order other than those illustrated or described herein.

The above are only preferred embodiments of the present disclosure and are not intended to limit the present disclosure. For those skilled in the art, the present disclosure may have various modifications and changes. Any modification, equivalent replacement, or improvement made within the spirit and principle of the present disclosure shall fall within the claimed scope of the present disclosure.

What is claimed is:

1. A single LCD projector structure switchable between ultra-short distance projection and medium-long distance projection, comprising a projection module which comprises an LED light source, a condenser cup, a collimating Fresnel lens, an LCD light valve and a focusing Fresnel lens arranged in sequence, the single LCD projector structure further comprising:
a first total reflection mirror;
an objective lens module, comprising:
an objective lens ring;
a telescopic mechanism configured for stretching and retracting of the objective lens ring in a Z-axis direction thereof;
wherein, light beams are emitted from the LED light source, pass through the condenser cup, and are collimated by the collimating Fresnel lens, pass through the LCD light valve and the focusing Fresnel lens along a first optical axis, and are reflected by the first total reflection mirror, which is 45 degrees tilted relative to the first optical axis, to form a right-angle reflection and exit through the objective lens module for projection imaging along a second optical axis.

2. The single LCD projector structure switchable between ultra-short distance projection and medium-long distance projection according to claim 1, wherein the projection module is tilted relative to a horizontal plane to form an angle c therebetween, the light beams is projected along the first optical axis, reflected by the first total reflection mirror tilted 45 degrees relative to the first optical axis to form a right-angle reflection, and pass through the objective lens module along the second optical axis.

3. The single LCD projector structure switchable between ultra-short distance projection and medium-long distance projection according to claim 2, further comprising:
a second total reflection mirror located after the objective lens module along the second optical axis for reflecting the light beams and folding an optical path of the light beams,
wherein an included angle a1 is formed between the second optical axis and the second total reflection mirror, an included angle b is formed between the second optical axis and a vertical line passing through the second total reflection mirror, and an included angle a2 is formed between the vertical line and the second total reflection mirror.

4. The single LCD projector structure switchable between ultra-short distance projection and medium-long distance projection according to claim 3, wherein a reflective surface of the second total reflection mirror is a plane, and the included angle a1 is a light incident angle and equal to the included angle a2 which is a light ejection angle.

5. The single LCD projector structure switchable between ultra-short distance projection and medium-long distance projection according to claim 4, wherein relationships of the included angles a1, a2, b, and the angle c meet:
$$a 1 = a 2 ;$$
$$a 1 + b + a 2 = 180 ° ;$$
wherein an included angle between the first optical axis and the second optical axis is 90°, the vertical line is perpendicular to the horizontal plane, and a sum of inner angles of a quadrilateral formed by the first optical axis, the second optical axis, the vertical line and the horizontal plane is 360°,
$$( 180 ° - c ) + 90 ° + 90 ° + b = 360 ° ,$$
thus: b=c.

6. The single LCD projector structure switchable between ultra-short distance projection and medium-long distance projection according to claim 5, wherein the included angle b and the angle c are ranged from 64° to 70°, and the included angles a1 and a2 are ranged from 55° to 58°.

7. The single LCD projector structure switchable between ultra-short distance projection and medium-long distance projection according to claim 1, wherein the telescopic mechanism comprises:
a fixing sleeve, wherein an outer side of the fixing sleeve is formed with two positioning pins symmetrical to each other and defined with vertical grooves;
a rotating sleeve, wherein an outer side of the rotating sleeve is provided with inclined grooves corresponding to each other and I-shaped positioning sliding grooves symmetrical to each other, the rotating sleeve is sleeved on the fixing sleeve, and the positioning pins are received in the I-shaped positioning sliding grooves for limiting and sliding;
at least two connecting pins, wherein the at least two connecting pins pass through the inclined grooves and the vertical grooves of the fixing sleeves correspondingly to fixedly connect with the objective lens ring.

8. The single LCD projector structure switchable between ultra-short distance projection and medium-long distance projection according to claim 2, wherein the second total reflection mirror is detachably disposed.

9. The single LCD projector structure switchable between ultra-short distance projection and medium-long distance projection according to claim 3, wherein the second total reflection mirror is detachably disposed.

10. A single LCD projector, comprising:
a single LCD projector structure switchable between ultra-short distance projection and medium-long distance projection, comprising:
a projection module, comprising:
an LED light source;
a condenser cup;
a collimating Fresnel lens;
an LCD light valve; and
a focusing Fresnel lens, wherein the LED light source, the condenser cup, the collimating Fresnel lens, the LCD light valve and the focusing Fresnel lens are arranged in sequence;
a first total reflection mirror; and
an objective lens module, comprising:
an objective lens ring;
a telescopic mechanism configured for stretching and retracting of the objective lens ring in a Z-axis direction thereof;
wherein, light beams are emitted from the LED light source, pass through the condenser cup, and are collimated by the collimating Fresnel lens, pass through the LCD light valve and the focusing Fresnel lens along a first optical axis, and are reflected by the first total reflection mirror, which is 45 degrees tilted relative to the first light axis, to form a right-angle reflection and exit through the objective lens module for projection imaging along a second optical axis.

11. The single LCD projector according to claim 10, wherein the projection module is tilted relative to a horizontal plane to form an angle c therebetween, the light beams are projected along the first optical axis, reflected by the first total reflection mirror tilted 45 degrees relative to the first optical axis to form a right-angle reflection, and pass through the objective lens module along the second optical axis.

12. The single LCD projector according to claim 11, wherein the single LCD projector structure switchable between ultra-short distance projection and medium-long distance projection further comprises:
a second total reflection mirror located after the objective lens module along the second optical axis for reflecting the light beams and folding an optical path,
wherein an included angle a1 is formed between the second optical axis and the second total reflection mirror, an included angle b is formed between the second optical axis and a vertical line passing through the second total reflection mirror, and an included angle a2 is formed between the vertical line and the second total reflection mirror.

13. The single LCD projector according to claim 12, wherein a reflective surface of the second total reflection mirror is a plane, and the included angle a1 is a light incident angle and equal to the included angle a2 which is a light ejection angle.

14. The single LCD projector according to claim 13, wherein relationships of the included angles a1, a2, b, and the angle c meet:
$$a 1 = a 2 ;$$
$$a 1 + b + a 2 = 180 ° ;$$
wherein an included angle between the first optical axis and the second optical axis is 90°, the vertical line is perpendicular to the horizontal plane, and a sum of inner angles of a quadrilateral formed by the first optical axis and the second optical axis, the vertical line and the horizontal plane is 360°,
$$( 180 ° - c ) + 90 ° + 90 ° + b = 360 ° ,$$
thus: b=c.

15. The single LCD projector according to claim 14, wherein the included angle b and the angle c are ranged from 64° to 70°, and the included angles a1 and a2 are ranged from 55° to 58°.

16. The single LCD projector according to claim 10, wherein the telescopic mechanism comprises:
a fixing sleeve, wherein an outer side of the fixing sleeve is formed with two positioning pins symmetrical to each other and defined with vertical grooves, and the vertical grooves are disposed alternating with the positioning pins;
a rotating sleeve, wherein an outer side of the rotating sleeve is provided with inclined grooves corresponding to each other and I-shaped positioning sliding grooves symmetrical to each other, the rotating sleeve is sleeved on the fixing sleeve, and the positioning pins are received in the I-shaped positioning sliding grooves for limiting and sliding;
at least two connecting pins, wherein the at least two connecting pins pass through the inclined grooves and the vertical grooves of the fixing sleeves correspondingly to fixedly connect with the objective lens ring.

17. The single LCD projector according to claim 11, wherein the second total reflection mirror is detachably disposed.

18. The single LCD projector according to claim 12, wherein the second total reflection mirror is detachably disposed.
